(19) United States
(12) Patent Application Publication
(10) Pub. No.: US 2012/0325359 A1
(43) Pub. Date: Dec. 27, 2012

(54) FLEXIBLE MAGNETIC CORE ELECTRONIC MARKER

(75) Inventors: Ziyad H. Doany, Austin, TX (US); Dean M. Dowdle, White Bear Lake, MN (US); William C. Egbert, Minneapolis, MN (US); Michael E. Hamerly, Vadnais Heights, MN (US); Terrence H. Joyce, JR., Lakeville, MN (US)

(73) Assignee: 3M Innovative Properties Company

(21) Appl. No.: 13/169,687

(22) Filed: Jun. 27, 2011

(51) Int. Cl. F16L 55/00; G06K 19/067; H01F 7/06

(52) U.S. Cl. 138/104; 29/602.1; 235/492

(57) ABSTRACT

An electronic marker and method of making an electronic marker for marking obscured articles. The marker includes a core made of flexible, and sometimes high permeability magnetic material and a solenoid disposed around the core. A capacitor is electrically coupled with the solenoid, and the marker is tuned to respond to a signal at a characteristic resonant frequency. The marker can attached to a conduit to be buried underground. The marker can further include a radio frequency identification chip.

### FIELD OF INVENTION

The present disclosure relates to electronic marking of obscured or buried infrastructure, such as flexible plastic pipe or other conduits. More specifically, the present disclosure relates to electronic markers with flexible magnetic cores for use in marking obscured or buried infrastructure.

### BACKGROUND

Conduits, such as pipes for water, gas and sewage, and cables for telephone, power and television are buried underground around the world. It often becomes important to know the location of a conduit or other underground or obscured asset or pipe. For example, a construction company may want to ensure they are not damaging any obscured assets before digging for a foundation. A gas company has an interest in being able to locate its underground pipes when they leak. A telephone company may need to connect new telephone cables to existing cables. In each of these instances, it can be useful to know not only where an underground asset is buried, but also what kind of asset is buried there and who owns it.

Several different types of pipes and cables may benefit from providing some type of device or means that enables one to subsequently locate an obscured asset. One such example is steel or plastic pipes used for gas or water distribution. When a construction company is installing steel or traditional polyvinyl chloride (PVC) pipe, they typically dig a trench and lay the pipe in the trench. To electrically mark the location of the pipe, they may also bury electronic markers along with the pipe. These markers are typically made of a resonant radio frequency (RF) circuit that includes an inductor and a tuning capacitor. The inductor generally is constructed as an air coil loop or a solenoid around a rigid ferrite rod. Both serve as magnetic field coupling devices. These antennas provide a directional field and are placed with their axis pointing upward. Large disc-shaped electronic markers are placed flat when buried. Ball shaped markers may use a self-leveling disk marker inside floating in a fluid. Some ball marker designs use three separate coils placed orthogonally to each other. Ball markers do not require careful orientation for accurate location. Markers using ferrite rod antennas are typically used for shallow applications, i.e., so that the markers are near the surface. Some electronic markers include an RFID chip for adding information or read/write capability. Alternatively or additionally, tracer wire may be installed and later located by applying a low frequency AC current to the wire. The current generates a magnetic field around the wire that can be detected by a portable magnetic field detector known as a cable or pipe locator. Presently, markers having ferrite rod antennas are typically placed at some separation from a pipe or cable, principally due to the marker lacking flexibility because of the rigidity of the ferrite rod antenna.

Pipes and cables can also be buried underground through a horizontal directional drilling (HDD) process. When a pipe or cable is disposed underground, the process begins with drilling a receiving hole and entrance pits. These pits allow drilling fluid to be collected and reclaimed to reduce costs and prevent waste. In one method, the process can begin with pilot boring, where a pilot hole is first drilled on the designated path. Next, the hole is enlarged by passing a larger cutting tool, such as a back reamer through the pilot hole. In the third stage, the pipe, cable or casing for the pipe or cable is placed in the hole, often by being pulled behind the reamer to center the pipe in the newly reamed path. To facilitate the HDD process, a viscous fluid knows as drilling fluid is often pumped to the cutting tool or drill bit. The drilling fluid can facilitate the removal of cuttings, stabilize the bore hole, cool the cutting head and lubricate the passage of the pipe into the hole.

When pipe is installed by HDD, traditional markers such as a ferrite or ball markers cannot be used to electronically mark the location of the pipe as they are not capable of being drawn through the bore hole with the pipe or cable. Therefore, a marker for pipe or cable disposed by HDD that can also be used with pipes or cables disposed in trenches would be welcomed.

### SUMMARY

The present disclosure is directed generally to an electronic marker with a flexible, magnetic, and in some embodiments, high-permeability antenna core which enables the marker to be attached to flexible pipe or cable. Such a pipe or cable can be coiled and the marker can flex with the pipe, conduit or cable. Many traditional electronic markers include an antenna core made of ferrite. Such a core can shatter easily, resulting in a failure of the marker resulting in an inability to locate the marker, and further causing loss of time and money. A flexible marker can withstand some level of impact and torsion without breaking and while retaining its functionality.

Additionally, a marker with a flexible core consistent with the present disclosure can successfully be used in the horizontal directional drilling process and can be successfully pulled through a non-linear hole along with a pipe, cable, conduit or casing or as part of a pipe, cable or casing.

Further, a flexible magnetic marker consistent with the present disclosure allows for significant signal gain when compared to a similar marker with an air core solenoid antenna structure. A flexible marker consistent with the present disclosure is adaptable to attach to a pipe or conduit, allowing detection of pipes and associated markers buried at a substantial underground depth. The length of the ferrite is proportional to the aperture of the marker antenna compared to the cross-sectional area in an air coil antenna marker.

The design of a marker consistent with the present disclosure provides several unique advantages specifically for attachment to pipes, and pipes with small diameters. For example, the high relative permeability of a marker with a flexible magnetic core consistent with the present disclosure compared to a marker with an air core allows a marker designed with a long and thin shape, which enables attachment to small diameter pipes. Further, a long and thin marker consistent with the present disclosure, when attached to a pipe, will maintain its orientation with respect to the pipe, which enhances pipe location accuracy.

In one aspect, the present disclosure includes an electronic marker for marking obscured articles. The marker includes a core made of flexible magnetic material and a solenoid disposed around the core. A capacitor is electrically coupled with the solenoid, and the marker is tuned to respond to a signal at a characteristic resonant frequency.

In another aspect, the present disclosure includes a method of making an electronic marker for marking obscured articles. The method includes steps of (a) providing a core made of flexible magnetic material; (b) disposing a solenoid around the core; and (c) electrically coupling a capacitor with the solenoid, such that the marker is tuned to respond to a signal at a characteristic resonant frequency.

In yet another aspect, the present disclosure includes a conduit to be disposed underground, including a fluid or gas impermeable body. An electronic marker is attached to the body. The marker includes a core made of flexible magnetic material, a solenoid disposed around the core, and a capacitor electrically coupled with the solenoid, wherein the marker is tuned to respond to a signal at a characteristic resonant frequency. A resonant marker as such can optionally be equipped with an RFID chip as the resonant circuit can provide power to operate such a chip.

### BRIEF DESCRIPTION OF THE DRAWINGS

The invention may be more completely understood in consideration of the following detailed description of various embodiments of the invention in connection with the accompanying drawings in which:

FIG. 1 shows a perspective view of an exemplary marker with a core made of flexible magnetic material consistent with the present disclosure;

FIG. 2 shows a cross section view of an exemplary marker with a core made of flexible magnetic material with a flexible housing;

FIG. 3 shows a perspective view of an exemplary spool of wound flexible plastic pipe with markers consistent with the present disclosure attached to the pipe;

FIG. 4 shows a side view of an exemplary marker with a core made of flexible magnetic material bent to a radius of approximately 0.6 meters; and

FIG. 5 shows a side view of an exemplary marker with a core made of flexible magnetic material bent to a radius of approximately 0.3 meters.

The accompanying drawings illustrate various embodiments of the present invention. The embodiments may be utilized, and structural changes may be made, without departing from the scope of the present invention. The figures are not necessarily to scale. Like numbers used in the figures generally refer to like components. However, the use of a number to refer to a component in a given figure is not intended to limit the component in another figure labeled with the same number.

### DETAILED DESCRIPTION

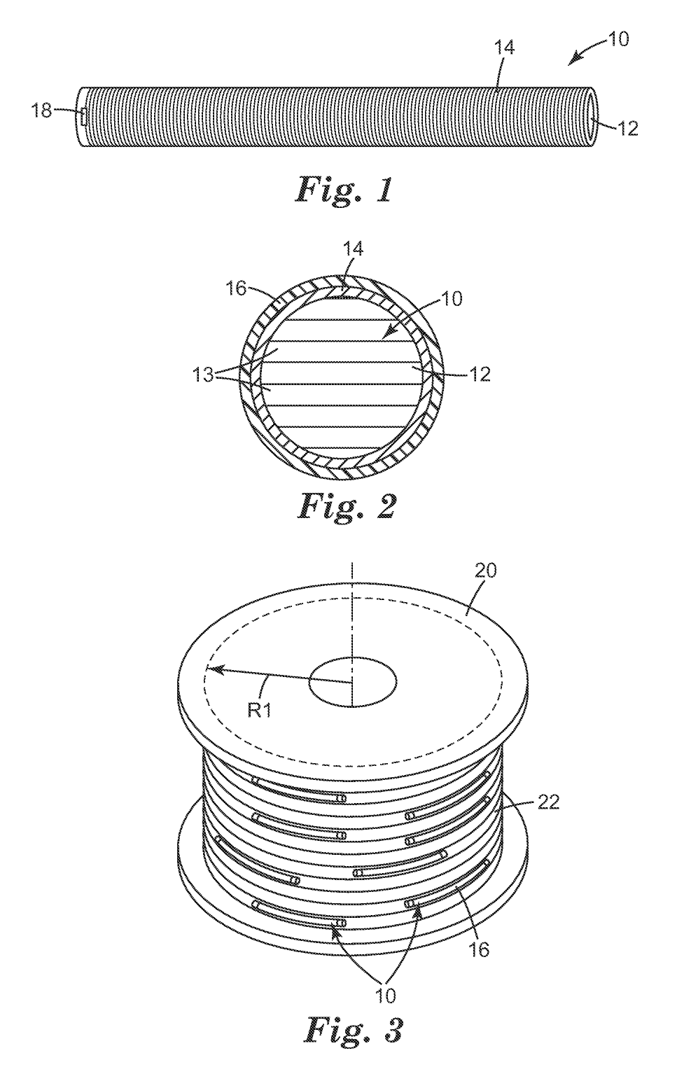

FIG. 1 shows a perspective view of an exemplary marker 10 with a core 12 made of flexible magnetic material. Marker 10 is an electronic marker and can be used to mark the location of obscured articles or assets, such as underground pipes, cables or conduits. Marker 10 includes a flexible magnetic core 12. Core 12 can be made of any appropriate flexible magnetic material so as to enhance the permeability and performance characteristics of marker 10.

Marker 10 is designed with consideration for a variety of key performance characteristics. These characteristics include: characteristic resonant frequency, resonance quality factor (Q), and flexibility. Size can also be an important factor.

As mentioned above, core 12 can be made from a variety of materials, including magnetically soft, low-coercivity, high permeability, low loss, flexible magnetic materials. An example of one such material is the 3M™ AB5000 series material sold by 3M Company of St. Paul, Minn. This material includes magnetic fillers loaded in a flexible polyethylene resin. The material is sold with pressure sensitive adhesive on one side, which is optional consistent with the present disclosure. Alternatively, any appropriate flexible magnetic material known in the art can be used for core 12. One example of such a material is molybdenum permalloy powder bound in a flexible resin or other material. If a 3M™ AB5000 series material is used for core 12, multiple layers of the material can be stacked to form a core of desired thickness as discussed further with respect to FIG. 2. A core 12 can be any appropriate dimensions. For example, a core 12 may have a thickness or diameter of 3 mm, 6 mm, 8 mm, or any number between or more or perhaps less depending upon the specific application. Core 12 can have substantially uniform flexibility such that the bend radius of the core or of the marker 10 as a whole is the same at any point along the marker. A marker with a smaller bend radius is generally more flexible. A marker consistent with the present disclosure may have any appropriate bend radius, such as 0.10 m, 0.20 m, 0.40 m, 0.50 m or any amount in between or more or less. Core 12 can also be made of a homogeneous flexible magnetic material such that the material is uniform across the length of the marker, without breaks, cuts, or joints.

Solenoid 14 can be made from a variety of materials and can be disposed about core 12 with a variety of methods. For example, solenoid 14 can be made of a thin copper (or other types of) magnet wire, for example, 26 or 24 AWG magnet wire or similar wrapped around core 12. Larger cross-section (lower AWG number) magnet wire may also be used for increasing marker Q. Solenoid 14 can be wrapped directly around core 12, or can be wrapped around a casing, such as a flexible tube that core 12 can be later inserted into. When designing solenoid 14, signal magnitude is an important consideration. The greater the signal magnitude, the greater the depth at which an underground pipe or other obscured asset can be located. The signal strength of a marker is proportional to marker length and the quality factor (Q). The Q of a marker can be increased by increasing the volume of core 12 and by decreasing the resistance of the windings of solenoid 14. The resistance of the winding of solenoid 14 can be decreased by two ways: increasing the cross-sectional area of solenoid 14 wire and/or by decreasing the total length of the windings that make up solenoid 14. The length of the windings of solenoid 14 can be minimized by wrapping the windings directly onto core 12 as mentioned above. The winding length can also be minimized by choosing a core shape that minimizes the ratio of the core volume to winding surface area. The theoretically optimal core shape is cylindrical, as discussed in Example 3, which can be more practical than other core shapes such as rectangles or squares. An oblong shape, a shape such as a rectangle, or a relatively flat shape can be desirable to reduce the total profile of marker 10 when attached to a pipe or conduit; however, such a shape results in a lower core volume to winding surface area ratio, and a lower marker Q.

Capacitor 18 can be used to create a marker with a desired characteristic resonant frequency or to tune a marker to a desired characteristic resonant frequency. The characteristic resonant frequency of a marker (fᵣ) is determined by the solenoid inductance and capacitor capacitance according to the formula:

$${f}_{r} = \frac{1}{2 π \sqrt{LC}} Hz$$

For example, a marker with an inductance of 2.29 milli Henrys and a capacitance of 521 pico Farads will have a characteristic resonant frequency of 145.7 kHz. Capacitor 18 is a non-polarized, low-loss capacitor, such as a ceramic or metallized foil capacitor.

FIG. 2 shows a cross section view of an exemplary marker 10 with a core 12 made of flexible magnetic material with a flexible housing 16. As shown in FIG. 2, core 12 is made of multiple layers 13 of flexible magnetic material, as is possible with a material such as one belonging to the 3M™ AB5000 series. Using core layers 13 instead of a solid core may have the additional advantage of increasing the flexibility of marker 10.

Solenoid 14 is disposed about core 12 as shown. The shape of solenoid 14 can be dependent upon the cross section of core 12. Additionally, in some embodiments there can be an intervening layer, such as a flexible tube, between core 12 and solenoid 14. This allows solenoid 14 to be wrapped directly onto the tube.

Housing 16 is disposed about solenoid 14, and can be made of any appropriate material. This can include, for example, high density polyethylene (HDPE) or a heat shrink material, such as 3M™ Scotchtite™ heat shrink tubing from 3M Company of St. Paul, Minn., or any other appropriate heat shrink materials. Housing 16 can be a fluid impermeable material so as to protect marker 10 from any potentially harmful elements, such as water, animals, erosion, and such. Housing 16 can be flexible such that it can bend and flex along with marker 10. This allows marker 10 to be disposed inside housing 16 and on a pipe or conduit while maintaining appropriate flexibility.

FIG. 3 shows an exemplary view of a spool 20 of wound flexible plastic pipe 22 with markers 10 consistent with the present disclosure attached to the pipe. Such a spool 20 of pipe 22 as shown could be used in applications such as horizontal directional drilling or trenching. As shown, markers 10 are attached directly to pipe 22 and encapsulated in housing 16. Housing 16 can be made of the same material as pipe 22 (such as HDPE) or may be made of a different material. Markers 10 can be attached to plastic pipe 22 in the same extrusion process in which plastic pipe 22 is made, thereby also making housing 16 simultaneously. Markers consistent with the present disclosure can be of appropriate length to create a useable signal strength for detecting the marker when obscured or buried underground. For example, as further illustrated in the Examples section, a marker may have a minimum length of 0.15 m, 0.20 m, 0.30 m, 0.5 m, 0.6, or any length in between these lengths. As noted elsewhere, the gain or signal strength of a marker can be increased by increasing the length of a marker. In some applications, a longer marker may be selected for an application requiring a longer read range.

In another embodiment, markers 10 can be attached to plastic pipe 22 or to a conduit after plastic pipe 22 or a conduit is extruded. Markers 10, in some embodiments, can be encapsulated in a body of the conduit or plastic pipe 22. Markers 10 could be encapsulated in the body of a conduit or plastic pipe 22 during the extrusion process.

In yet another embodiment, markers 10 can be attached on a cord, rope, or other elongated structure or support and rolled onto the same spool as plastic pipe 22 so as to be pulled through a hole in the HDD process simultaneously with plastic pipe 22, separately from plastic pipe 22, or simply disposed in a conduit that was buried underground using the HDD process. Markers 10 attached to a support can be associated with an asset buried underground. For example, when an elongated structure including multiple markers 10 is pulled through a conduit buried underground, the markers can be associated with the conduit or with other assets in the conduit, such as fiber optic or other cables.

Spool radius R1 can be any appropriate radius, for example, 0.50 m, 0.75 m, 1.0 m, any distance in the range of these numbers or greater or less. Spool radius R1 can be related to the diameter of a plastic pipe 22 wound around spool 20. For example, a plastic pipe 22 with a greater diameter may require a larger spool radius R1. Spool radius R1 can be the same as a bend radius of electronic marker 10 or may be greater.

### Example 1

### Flexible Core Marker Signal Strength

A flexible, high permeability magnetic core inside a coil significantly increases the coil inductance, marker Q, and read distance when compared to a marker without such a core.

A coil with a finished length of 0.30 m was wound onto a 12 mm diameter hollow glass rod to form an inductive coil.

A flexible marker core consistent with the present disclosure was constructed of 3M™ AB5030 material. The 3M™ AB5030 material had a thickness of approximately 0.30 mm and a preferred magnetic orientation (down-web). Multiple layers were laminated together to form a core approximately 0.30 m long, 6.4 mm thick and 6.4 mm wide. The marker core was inserted inside the hollow glass rod described above. A 514 pF capacitor was coupled to the solenoid.

The coil inductance, marker Q and read range at 145.7 kHz of both the coil without a core and the coil with the flexible marker core as described above were measured and compared as shown in the table below. A 3M™ Dynatel™ 1420 Locator was used to measure the read range for both items. As shown below, a marker with a flexible core consistent with the present disclosure had a superior performance when compared to a coil without a core.

TABLE 1
Marker Inductance, Q and Read Range

| | | Coil with Flexible |
|---|---|---|
| | Coil without Core | Marker Core |
| Coil Inductance (mH) | 2.32 | 2.32 |
| Q | 33 | 172 |
| Read Range (m) | 0.508 | 2.46 |

### Example 2

### Marker Flexibility

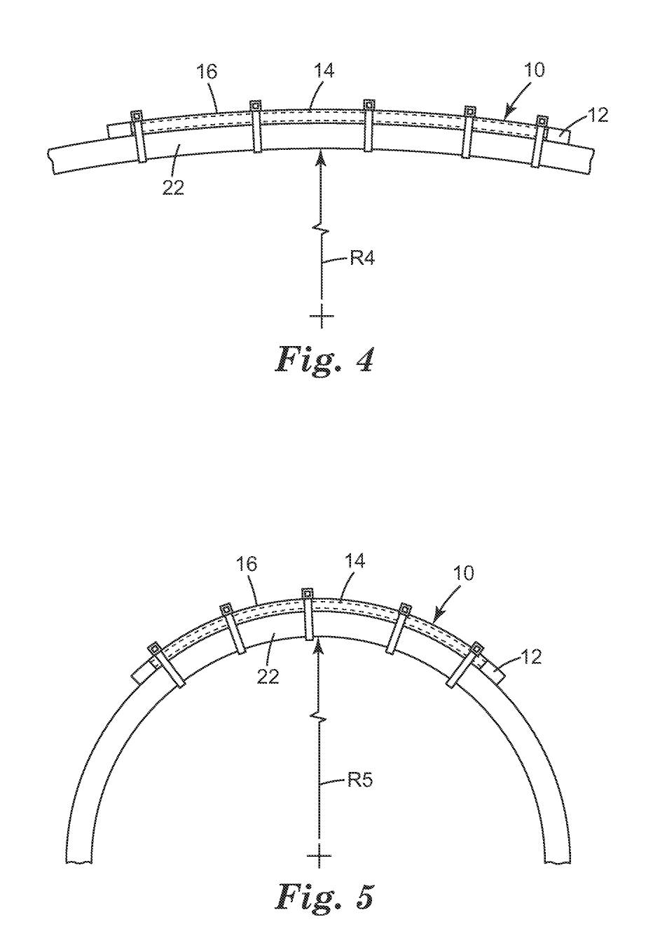

An inventive flexible marker was constructed consistent with the present disclosure. FIGS. 4 and 5 illustrate the test arrangement of the marker attached to a flexible pipe and bent to varying radii. The flexible marker core 12 was constructed of 3M™ AB5030 material as described in Example 1. A solenoid 14 made of copper wire was wound about the core. A capacitor with a capacitance of 514 pF was electrically coupled to the solenoid 14. A housing 16 made of 3M™ Scotchtite™ heat shrink tubing from 3M Company of St. Paul, Minn., was disposed around the outside of marker 10, and the housing 16 containing marker 10 was attached to plastic pipe 22.

FIG. 4 illustrates the test arrangement wherein housing 16 containing marker 10 was attached to plastic pipe 22 and was bent to a bend radius of approximately 0.61 m. FIG. 5 illustrates the test arrangement wherein housing 16 containing marker 10 was attached to a plastic pipe 22 and was bent to a bend radius of 0.30 m.

To confirm that a marker 10 can be bent and retain its established resonant frequency and continue to provide an appropriate level of signal strength to be able to detect the marker at buried depths, the following measurements, presented in Table 2, were taken with housing 16 containing marker 10 bent to various radii. Signal strength measurements were taken with a 3M™ Dynatel™ 1420 Locator.

TABLE 2
Marker Bend Radius, Frequency and Signal Strength

| | | Marker | |
|---|---|---|---|
| | Bend | Resonant | Indicated |
| Housing/Marker | Radius | Frequency | Signal (dB) at a |
| Configuration | (m) | (kHz) | distance of 1.524 m |
| Lying on a wooden bench | infinity | 145.75 | 23 |
| Tie-wrapped to cross-linked | infinity | 145.6 | 23 |
| polyethylene (PEX) pipe | | | |
| Tie-wrapped to PEX pipe | 0.689 | 145.75 | 23 |
| Tie-wrapped to PEX pipe | 0.610 | 145.75 | 22 |
| Tie-wrapped to PEX pipe | 0.508 | 145.75 | 21 |
| Tie-wrapped to PEX pipe | 0.457 | 145.75 | 18 |

Table 2 above shows that the marker signal strength slightly decreased as bend radius decreased, while the marker frequency remained relatively stable. It is postulated that the decrease in signal strength was likely due to the fact that the ends of the markers were farther from the locator for decreasing bend radius.

When the pipe with housing 16 and marker 10 was relaxed from a bend radius of 0.51 m to a bend radius of 0.69 m (the natural bend radius for the PEX pipe used), the marker signal strength returned to 23 dB, while retaining its characteristic resonant frequency. This suggests that temporarily increasing the bending of the pipe with housing 16 and marker 10, i.e. subjecting the configuration of pipe with housing 16 and marker 10 to a smaller bend radius does not permanently affect marker performance. This is a particularly important performance characteristic as flexible pipe that may ultimately be laid underground may be rolled up, i.e., bent during transportation, but will be straightened out when installed.

### Example 3

### Marker Core Cross Sectional Shapes

As mentioned elsewhere, the cross-sectional area has an impact on winding length of a solenoid, and thereby impacts the Q of a marker. The signal from a marker is proportional to marker length and Q. The Q of the markers can be increased by increasing the volume of the magnetic core material and by decreasing the alternating current (AC) resistance of the windings. The winding resistance can be decreased by increasing the wire cross-sectional area of the wire (i.e., lower wire gauge number), or by decreasing the length of the windings. The length of the windings can be minimized by wrapping the windings directly onto the magnetic core material instead of onto a hollow form into which the magnetic core is placed. The winding length can also be minimized by choosing a core shape that minimizes the ratio of the winding surface area to core volume ratio. The ratio of the volume of the flexible magnetic core over various shapes, specifically a cylinder, a square and a rectangle, to the uniform winding surface area was mathematically derived and is presented in Table 3 below. In the table below, “h” represents marker length and “r” represents the radius of a circle with the winding surface area listed above.

TABLE 3
Ratio of Core Volume to Winding Area for various Marker Shapes

| Cross-Sectional Shape | Cross Sectional Dimensions | Volume | Winding Surface Area | $\frac{Volume}{Winding Surface Area}$ |
|---|---|---|---|---|
| Circle | radius = r | πr²h | 2πrh | 0.5r |
| Square | $side length = \frac{π r}{2}$ | $\frac{π \text{?}}{4}$ $\text{?} \text{indicates text missing or illegible when filed}$ | 2πrh | 0.3927r |
| Rectangle | $\begin{matrix}side 1 length = \frac{π r}{4} \\ side 2 length = \frac{3 π r}{4}\end{matrix}$ | $\frac{\text{?} {π}^{2} {r}^{2} h}{16}$ $\text{?} \text{indicates text missing or illegible when filed}$ | 2πrh | 0.294r |

$\text{?}$ $\text{?} \text{indicates text missing or illegible when filed}$

The calculated ratio results of the core volume to the winding area for various marker shapes as presented in Table 3 demonstrate that the optimal core shape is cylindrical because it has the greatest volume to winding surface area ratio. The square has the next greatest winding to cross-sectional area ratio. In some embodiments, the square cross section may be a more practical core shape if the core is composed of multiple thin laminations. A rectangular cross-section may also be desirable in that it decreases the marker thickness in some applications, but results in a lower cross sectional volume to winding surface area ratio.

### Example 4

### Varying Marker Parameters

To confirm the mathematically predicted effects set forth in Example 3, markers with various parameters were constructed and measured. A first or control marker was constructed and measured, and then various marker parameters of the marker were individually varied to demonstrate the interaction of marker characteristics by comparing the results produced by each change to the measured results of the first or control marker. The parameters of each marker constructed and measured are shown in Table 4 below. Marker #1 is the control marker. For markers #2-7, the altered parameter is highlighted. All maximum read distances and signal amplitude were measured with the 3M™ Dynatel™ 1420 Locator.

TABLE 4
Varying Marker Parameters

| | | | | | | | | Max | |
|---|---|---|---|---|---|---|---|---|---|
| | Core | | Winding | | | | | Read | Signal |
| | Dimensions | Strip | Length | | | Inductance | | Distance | Amplitude |
| Marker | (mm) | Layers | (mm) | Turns | AWG | (mH) | Q | (m) | (dB) |
| 1 | 305 × 6.35 × 6.35 | 20 | 302 | 650 | 26 | 2.29 | 147 | 2.46 | 72 |
| 2 | 305 × 6.35 × 6.35 | 20 | 302 | 650 | 26 | 2.32 | 160 | 2.62 | 74 |
| 3 | 305 × 6.35 × 6.35 | 20 | 302 | 575 | 24 | 1.52 | 140 | 2.46 | 75 |
| 4 | 305 × 6.35 × 3.18 | 10 | 302 | 650 | 26 | 1.61 | 134 | 2.31 | 70 |
| 5 | 305 | 15 | 305 | 650 | 26 | 1.39 | 137 | 2.29 | 75 |
| 6 | 305 × 6.35 × 1.59 | 5 | 302 | 650 | 26 | 0.749 | 23 | 1.27 | 45 |
| 7 | 153 × 6.35 × 6.35 | 20 | 151 | 325 | 26 | 1.04 | 143 | 2.11 | 67 |

The first or control marker (#1) was constructed with a core composed of 20 3M™ AB5030 magnetic strips stacked on top of each other to form the core dimension denoted for Marker 1 in Table 4. The core was inserted into a glass tube with a 12 mm diameter, and a solenoid was constructed around the glass tube by winding magnetic wire around the glass tube to the length identified in Table 4 as winding length for marker #1. The number of turns in constructing the solenoid to achieve this length was 650; the copper wire was 26 gauge. The measured solenoid inductance is the value denoted as Inductance for Marker #1, and a capacitor was coupled to the solenoid to tune the marker to a frequency of 145.7 kHz. The marker Q was 147, the marker was read at a maximum distance of 2.46 m with the locator (the maximum distance at which a signal strength above background was measured) and the signal amplitude at a distance of 0.51 m between the marker and the locator was 72 dB.

Marker #2 was constructed identical to marker #1, except the solenoid for marker #2 was wrapped directly onto the core and not onto a glass tube. Marker #2 had a higher Q and the marker was read at a maximum distance of 2.6 m with the locator and the signal amplitude at a distance of 0.51 m between the marker and the locator was 74 dB. The better performance for Marker #2 is postulated to be due to the overall shorter length of the magnetic wire required to produce the solenoid since the wire was wrapped directly onto the core, rather than the glass tube, and thus the associated decreased resistance due to a smaller core cross-section to wrap.

Marker #3 was constructed identical to Marker #1 except that 24 gauge wire was used instead of 26 gauge in winding the solenoid. This decreased the total number of turns required to achieve the same winding length. The resulting Q and maximum read distance was about the same as for Marker #1, though the signal amplitude was somewhat higher.

Marker #4 was constructed identical to Marker #1, but the core thickness was 3.18 mm, half that of Marker #1. The resulting Q, maximum read distance and signal amplitude were somewhat less than that of Marker #1, which was expected given the reduced volume of core material.

Marker #5 was constructed identical to Maker #1 except that the core was shaped differently: the core was composed of 15 strips of different widths of the 3M™ AB5030 material in such a manner as to emulate a circular cross section. Marker #5 had a decreased Q, maximum read distance and signal amplitude compared to Marker #1, also postulated to be due to the reduced volume of core material.

Marker #6 was constructed identical to Marker #1, but the core thickness was one-fourth that of Marker #1. A substantial drop in marker Q, maximum read distance, and signal amplitude was measured compared to Marker #1, also postulated to be due to the significant reduction in volume of core material.

Marker #7 was constructed identical to Marker #1, except that the core length was half that of Marker #1. A decrease in the marker Q, maximum read distance and signal amplitude was measured compared to Marker #1.

While these are several embodiments of marker constructions consistent with the present disclosure, they in no way are intended to limit the scope of the present disclosure. Upon reading this, an individual of ordinary skill in the art will be able to envision a variety of combinations and modifications consistent with the present disclosure.

Positional terms used throughout the disclosure, e.g., over, under, above, etc., are intended to provide relative positional information; however, they are not intended to require adjacent disposition or be limiting in any other manner. For example, when a layer or structure is to be “disposed over” another layer or structure, this phrase is not intended to be limiting on the order in which the layers or structures are assembled but simply indicates the relative spatial relationship of the layers or structures being referred to.

Many modifications and other embodiments of the invention will come to mind to one skilled in the art to which this invention pertains having the benefit of the teachings presented in the foregoing descriptions and the associated drawings. Therefore, it is to be understood that the invention is not limited to the specific embodiments disclosed and that modifications and other embodiments are intended to be within the scope of the appended claims. Although specific terms are employed herein, they are used in a generic and descriptive sense only and not for purposes of limitation.

What is claimed is:

1. An electronic marker for marking obscured articles, the marker comprising:
a core made of flexible magnetic material;
a solenoid disposed around the core; and
a capacitor electrically coupled with the solenoid, wherein the marker is tuned to respond to a signal at a characteristic resonant frequency.

2. The marker of claim 1, wherein the core has substantially uniform flexibility.

3. The marker of claim 1, wherein the core is comprised of homogenous flexible magnetic material.

4. The marker of claim 1, wherein the marker has substantially the same characteristic resonant frequency at a bend radius of least 0.3 meters as when straight.

5. The marker of claim 1, wherein the marker is disposed in a flexible housing.

6. The marker of claim 5, wherein the housing is fluid impermeable.

7. The marker of claim 5, wherein the housing is made of one of: high density polyethylene (HDPE) or a heat shrink material.

8. The marker of claim 5, wherein the housing with the marker has a bend radius of at least 0.3 meters while maintaining the characteristic resonant frequency of the marker and wherein the housing and the marker can be restored to their original bend radius.

9. The marker of claim 1, wherein the marker has an oblong cross-section.

10. The marker of claim 1, wherein the flexible magnetic material comprises a material from the 3M AB 5000 series.

11. An elongated support comprising a plurality of markers according to claim 1.

12. The marker of claim 1, further comprising a radio frequency identification chip.

13. A method of making an electronic marker for marking obscured articles, the method comprising:
(a) providing a core made of flexible magnetic material;
(b) disposing a solenoid around the core; and
(c) electrically coupling a capacitor with the solenoid, such that the marker is tuned to respond to a signal at a characteristic resonant frequency.

14. The method of claim 13, wherein the core has substantially uniform flexibility.

15. The method of claim 13, further comprising the following step:
(d) disposing the marker in a flexible housing.

16. The method of claim 15, wherein the housing is fluid impermeable.

17. The method of claim 15, wherein the housing is made of high density polyethylene (HDPE) or a heat shrink material.

18. The method of claim 13, wherein step (b) comprises wrapping wire around the core.

19. The method of claim 13, wherein the flexible magnetic material comprises a material from the 3M AB 5000 series.

20. The method of claim 13, further comprising:
(d) electrically coupling a radio frequency identification chip to the solenoid.

21. A conduit to be disposed underground, the conduit comprising:
a fluid or gas impermeable body;
an electronic marker attached to the body, wherein the marker comprises:
a core made of flexible magnetic material;
a solenoid disposed around the core; and
a capacitor electrically coupled with the solenoid, wherein the marker is tuned to respond to a signal at a characteristic resonant frequency.

22. The conduit of claim 21, wherein the marker is encapsulated in the body of the conduit.

23. The conduit of claim 21, wherein the marker further comprises a housing, and wherein the housing is made of the same material as the body.

24. The conduit of claim 21, wherein the marker further comprises a radio frequency identification chip.

25. The conduit of claim 21, wherein the flexibility of the marker is greater than or equal to the flexibility of the conduit.

26. The conduit of claim 21, wherein the marker length is in the range of 0.15 meters to 0.60 meters.

27. The conduit of claim 21, wherein the conduit is a pipe.
